(19) United States
(12) Patent Application Publication
(10) Pub. No.: US 2007/0016603 A1
(43) Pub. Date: Jan. 18, 2007

(54) Representing a distribution of data

(75) Inventors: Brian Robert Muras, Rochester, MN (US); Joseph Przywara, Livonia, MI (US)

Correspondence Address: IBM (ROC-BLF), C/O BIGGERS & OHANIAN, LLP, P.O. BOX 1469, AUSTIN, TX, 78767-1469, US

(73) Assignee: International Business Machines Corporation, Armonk, NY (US)

(21) Appl. No.: 11/181,709

(22) Filed: Jul. 14, 2005

(51) Int. Cl. G06F 7/00

(52) U.S. Cl. 707/102

(57) ABSTRACT

Representing a distribution of data by providing a first and a second representation of the distribution of data having defined ranges of data values and a magnitude for each range and creating a third representation of the distribution of data. At least one of the magnitudes for at least one of the ranges of data values in the second representation is more accurate than a magnitude for a corresponding range of data values in the first representation. Creating the third representation of the distribution of data may be carried out by establishing ranges of data values for the third representation in dependence upon ranges from both the first and second representations, and determining a magnitude for each range of data values in the third representation in dependence upon magnitudes for ranges of data values from the first and second representations.

### BACKGROUND OF THE INVENTION

1. Field of the Invention

The field of the invention is data processing, or, more specifically, methods, systems, and products for representing a distribution of data.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. The most basic requirements levied upon computer systems, however, remain little changed. A computer system's job is to access, manipulate, and store information. Computer system designers are constantly striving to improve the way in which a computer system can deal with information.

Information stored on a computer system is often organized in a structure called a database. A database is a grouping of related structures called ‘tables,’ which in turn are organized in rows of individual data elements. The rows are often referred to a ‘records,’ and the individual data elements are referred to as ‘fields.’ In this specification generally, therefore, an aggregation of fields is referred to as a ‘data structure’ or a ‘record,’ and an aggregation of records is referred to as a ‘table.’ An aggregation of related tables is called a ‘database.’

A computer system typically operates according to computer program instructions in computer programs. A computer program that supports access to information in a database is typically called a database management system or a ‘DBMS.’ A DBMS is responsible for helping other computer programs access, manipulate, and save information in a database.

A DBMS typically supports access and management tools to aid users, developers, and other programs in accessing information in a database. One such tool is the structured query language, ‘SQL.’ SQL is query language for requesting information from a database. Although there is a standard of the American National Standards Institute (‘ANSI’) for SQL, as a practical matter, most versions of SQL tend to include many extensions. Here is an example of a database query expressed in SQL:

select * from stores, transactions
where stores.location = “Minnesota”
and stores.storeID = transactions.storeID

This SQL query accesses information in a database by selecting records from two tables of the database, one table named ‘stores’ and another table named ‘transactions.’ The records selected are those having value “Minnesota” in their store location fields and transactions for the stores in Minnesota. In retrieving the data for this SQL query, an SQL engine will first retrieve records from the stores table and then retrieve records from the transaction table. Records that satisfy the query requirements then are merged in a ‘join.’

Databases are stores of data, of course, organized in tables, rows, and columns. The data in the tables, row, and columns is the ordinary operational data of direct concern to the users and organizations that rely upon it to run their businesses. Databases contain other data, however, beyond the operational data upon which users rely for business purposes. Databases contain metadata, data about data, data that describes characteristics of other data, including, for example, the operational data of the database. Metadata may describe, for example, how and when and by whom a particular set of operational data was collected, when it was accessed, and how the operational data is formatted. Metadata is helpful for understanding information stored in data warehouses and has become increasingly important in XML-based Web applications.

Database statistics are metadata. In a modem DBMS, database statistics are automatically generated by a statistics engine when an attempt to optimize the execution of a query finds useful database statistics missing or stale. Database statistics commonly include frequency statistics, histogram statistics, cardinality statistics, etc. describing operational data in columns of tables of a database.

Statistics engines typically provide statistics data for the columns of a table. This statistics data describes the distribution of the values within a column. A query optimizer associated with the DBMS may use this statistics data to plan the execution of a query. By using statistics as a representation of the data in a table, the optimizer may form an access plan to execute the query in a manner that is resource efficient.

A problem with typical database statistics is that the statistics themselves may take up considerable memory space. More accurate representations of a distribution of data require typically more memory to store. Less accurate representations require less storage space but, of course, are less accurate. On the other hand, searching through less accurate representations may require fewer memory accesses because there is less descriptive data to be searched for any particular statistic. Thus a database administrator may be faced with a tradeoff between allocating more memory to statistics to improve query execution, or allocating less memory to statistics to conserve memory space and attempt to improve performance.

### SUMMARY OF THE INVENTION

Exemplary methods, systems, and products are described for representing a distribution of data by providing first and second representations of the distribution of data. The first and second representations of the distribution of data each have defined ranges of data values and a magnitude for each range. Typically, at least one of the magnitudes for at least one of the ranges of data values in the second representation is more accurate than a magnitude for a corresponding range of data values in the first representation. A “corresponding range of data values” is a range of data values in the first representation that includes a range of data values in the second representation. In one embodiment, the first representation of the distribution of data may be a histogram and the second representation of the distribution of data may be a frequent values list. In another embodiment, the first representation of the distribution of data may be a histogram and the second representation of the distribution of data may be a spline.

A third representation of the distribution of data may be created by establishing ranges of data values for the third representation in dependence upon ranges from both the first and second representations and determining a magnitude for each range of data values in the third representation. In one example, ranges of data values are defined by quantiles. In this example, ranges of data values for the third representation are established by identifying quantiles defining ranges of data values of the third representation in dependence upon the quantiles defining the ranges for the first and second representations.

A magnitude for each range of data values in the third representation is determined in dependence upon magnitudes for ranges of data values from the first and second representations. The magnitude for a range of data values in the third representation may also be determined in dependence upon the range of data values in the third representation. For example, a magnitude for a range of data values in the third representation may be determined that is proportional to the difference between a magnitude for a range of data values from the first representation and a magnitude for a range of data values from the second representation. In this example, the determined magnitude may also be proportional to a size of the range of data values for the third representation, and inversely proportional to a size of the range of data values for the first representation.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an exemplary system for representing a distribution of data according to embodiments of the present invention.

FIG. 2 sets forth an additional block diagram of an exemplary system for representing a distribution of data according to embodiments of the present invention.

FIG. 3 sets forth a flow chart illustrating an exemplary method for representing a distribution of data according to embodiments of the present invention.

FIGS. 4A-4E set forth line drawings illustrating exemplary representations of a distribution of data and creating a third representation from a first and second representation according to embodiments of the present invention.

FIG. 5 sets forth an additional flow chart illustrating an exemplary method for representing a distribution of data according to embodiments of the present invention.

### DETAILED DESCRIPTION OF EXEMPLARY EMBODIMENTS

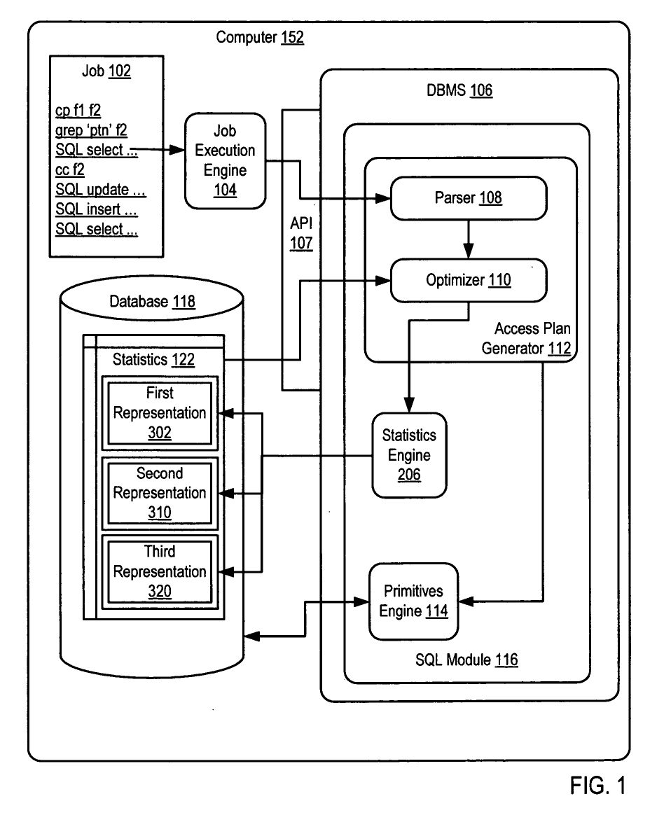

Exemplary methods, systems, and products for representing a distribution of data according to embodiments of the present invention are explained with reference to the accompanying drawings, beginning with FIG. 1. FIG. 1 sets forth a block diagram of an exemplary system for representing a distribution of data according to embodiments of the present invention. The exemplary system of FIG. 1 includes a computer (152) having a database (118) operated by a database management system (‘DBMS’) (106). DBMS (106) includes an SQL module (116) that in turn includes an access plan generator (112), a parser (108), an optimizer (110), and a statistics engine (206). DBMS (106) administers access to the contents of database (118). The SQL module is implemented as computer program instructions that execute SQL queries. Optimizer (110) optimizes the execution of SQL queries against DBMS (106). Optimizer (110) is implemented as computer program instructions that optimize execution of a SQL query in dependence upon database management statistics (122). Optimizer (110) is capable of optimizing execution of an SQL query in dependence upon database statistics (122) for a column of a database and discovering that the database statistics for the column are missing or stale. Database statistics may reveal, for example, that there are only two zip code values in a user account table—so that it is an optimization, that is, more efficient, to scan the user account table rather than using index access. Alternatively, database statistics may reveal that there are many user account records, only a few of which have zip code values in a range of interest—so that for a particular SQL query it is an optimization to access the user account table by an index.

Database statistics are typically implemented as metadata of a table, such as, for example, metadata of tables of database (118). Database statistics may include, for example, a representation of a distribution of data pertaining to database (118). A representation of a distribution of data is a method of describing the data in the database. Examples of ways of representing a distribution of data include:
A histogram: a range values and an associated count of values in the range,
A frequent values list: a frequency of occurrence of a range of value,
A spline: a smoothed representation of the data, and
A cardinality statistic: a count of the number of different values in a column.

These methods of representing a distribution of data are presented for explanation only, not for limitation. The use of any representation of a distribution of data as will occur to those of skill in the art is well within the scope of the present invention.

Optimizer (110) uses database statistics (122) from database (118) for optimizing SQL queries against database (118). Optimizer (110) notifies statistics engine (206) when the optimizer attempts to use databases statistics for a column of a table, for example, and finds the database statistics missing or stale. Statistics engine (206) generates the missing or stale statistics. Additionally, statistics engine (206) may generate one or more representations of the distribution of data in the database.

In the example of FIG. 1, SQL module (116) receives SQL queries for execution from job execution engine (104). Job execution engine (104) is a software module that executes jobs, such as job (102), by passing commands from the jobs to software applications appropriate to the command. Jobs may mingle SQL queries with other commands to perform various data processing tasks. Job (102), for example, includes several commands for execution as part of job (102), including:
cp f1 f2: an operating system command to copy one file to another file.
grep ‘ptn’ f2: a general regular expression command of the operating system to find occurrences of ‘ptn’ in file f2,
cc f2: a command to compile file f2 as a C program, and
several SQL commands, each of which passes as a parameter to an executable command named ‘SQL’ call parameters identifying an SQL query.

In this example, job execution engine (104) passes the operating system commands from job (102) to the operating system (not shown on FIG. 1) for execution and passes the SQL queries from job (102) to SQL module (116) for execution. Job execution engine (104) passes the SQL queries to SQL module (116) through application programming interface (‘API’) (107) of database management system (‘DBMS’) (106). DBMS (106) provides database management functions for database (118). DBMS (106) exposes API (107) to enable applications, including, for example, job execution engine (104) to access functions of the DBMS, including, for example, SQL module (116). The ‘SQL’ command illustrated in job (102) is a function made available through API (107).

The exemplary SQL module (116) of FIG. 1 includes an exemplary access plan generator (112). Each SQL query is carried out by a sequence of database operations specified as an access plan. The access plan generator of FIG. 1 is implemented as computer program instructions that create an access plan for a SQL query. An access plan is a description of database functions for execution of an SQL query. Taking the following SQL query as an example:

select * from stores, transactions
where stores.storeID = transactions.storeID,

access plan generator (112) may generate the following exemplary access plan for this SQL query:

tablescan stores
join to
index access of transactions

This access plan represents database functions to scan through the stores table and, for each stores record, join all transactions records for the store. The transactions for a store are identified through the storeID field acting as a foreign key. The fact that a selection of transactions records is carried out for each store record in the stores table identifies the join function as iterative.

The exemplary access plan generator (112) of FIG. 1 includes a parser (108) for parsing the SQL query. Parser (108) is implemented as computer program instructions that parse the SQL query. An SQL query is presented to SQL module (116) in text form, the parameters of an SQL command. Parser (108) retrieves the elements of the SQL query from the text form of the query and places them in a data structure more useful for data processing of an SQL query by an SQL module.

The exemplary access plan generator (112) also includes an optimizer (110) implemented as computer program instructions that optimize the access plan in dependence upon database management statistics. Database statistics may reveal, for example, that there are only two storeID values in the transactions table—so that it is an optimization, that is, more efficient, to scan the transactions table rather than using an index. Alternatively, database statistics may reveal that there are many transaction records with only a few transactions records for each storeID—so that it is an optimization, that is, more efficient, to access the transactions records by an index.

The exemplary SQL module (116) of FIG. 1 includes a primitives engine (114) implemented as computer program instructions that execute primitive query functions in dependence upon the access plan. A ‘primitive query function,’ or simply a ‘primitive,’ is a software function that carries out actual operations on a database, retrieving records from tables, inserting records into tables, deleting records from tables, updating records in tables, and so on. Primitives correspond to parts of an access plan and are identified in the access plan. Examples of primitives include the following database instructions:
retrieve the next three records from the stores table into hash table H1,
retrieve one record from the transactions table into hash table H2,
join the results of the previous two operations, and
store the result of the join in table T1.

The data base statistics (122) in the example of FIG. 1 include first (302), second (310), and third (320) representations of a distribution of data. The distribution of data is occurrences of data in a single column of a table in database (118). Only three representations are illustrated, but readers will recognize that typical embodiments will include more than three representations of data distributions in columns of a database.

The system of FIG. 1 operates generally to represent a distribution of data by providing through statistics engine (206) a first representation (302) of the distribution of data, providing through statistics engine (206) a second representation (310) of the distribution of data, and creating a third representation (320) of the distribution of data. Each representation has defined ranges of data values and a magnitude for each range. The statistics engine may create the third representation by establishing ranges of data values for the third representation in dependence upon ranges from both the first and second representations and determining a magnitude for each range of data values in the third representation in dependence upon magnitudes for ranges of data values from the first and second representations. At least one of the magnitudes for at least one of the ranges of data values in the second representation typically is more accurate than a magnitude for a corresponding range of data values in the first representation.

The system of FIG. 1 illustrates a system architecture for representing a distribution of data. This exact architecture, however, is presented only for explanation, not for limitation of the present invention. Many system architectures as will occur to those of skill in the art are functional for representing a distribution of data according to embodiments of the present invention, and all such architectures are well within the scope of the present invention.

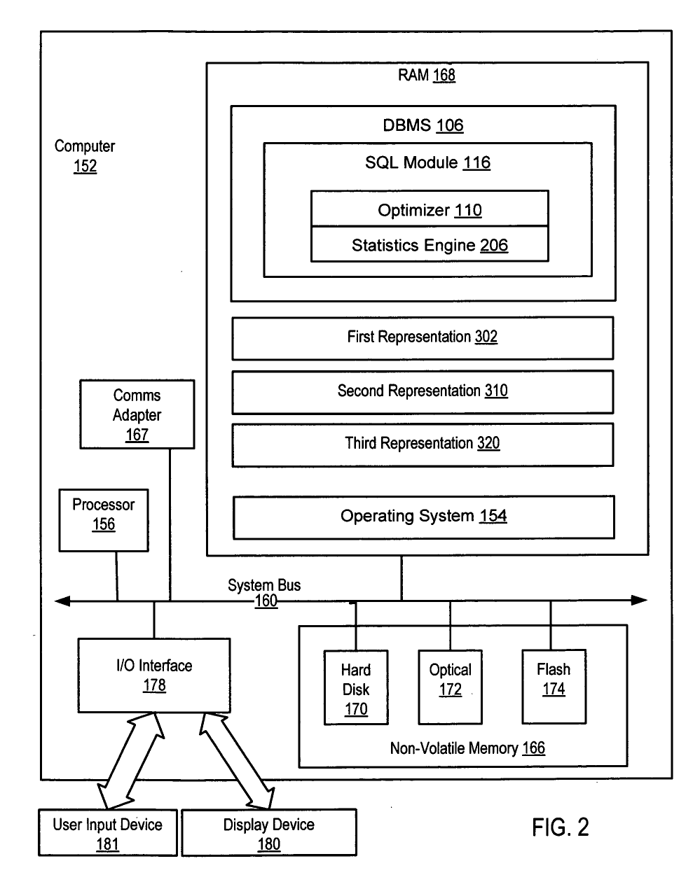

As mentioned above, representing a distribution of data in accordance with the present invention is generally implemented with computers, that is, with automated computing machinery. For further explanation, FIG. 2 sets forth a block diagram of automated computing machinery comprising an exemplary computer (152) useful for representing a distribution of data according to embodiments of the present invention. In addition to the system elements that were described above with respect to FIG. 1, the system of FIG. 2 includes some elements not discussed with regard to FIG. 1, and some of the elements shown in FIG. 1 are described further with regard to FIG. 2.

The computer (152) of FIG. 2 includes at least one computer processor (156) or ‘CPU’ as well as random access memory (168) (“RAM”) which is connected through a system bus (160) to processor (156) and to other components of the computer. Stored in RAM (168) is DBMS (106), computer program instructions for database management. The DBMS (106) of FIG. 2 includes an SQL module (116), which in turn includes an optimizer (110), and a statistics engine (206), each of which implement computer program instructions stored in RAM (168) that operate computer (152) to represent a distribution of data according to embodiments of the present invention.

Statistics engine (206) includes computer program instructions capable of causing the computer (152) of FIG. 2 to operate generally to represent a distribution of data by providing through statistics engine (206) a first representation (302) of the distribution of data, providing through statistics engine (206); a second representation (310) of the distribution of data; and creating a third representation (320) of the distribution of data. Each representation has defined ranges of data values and a magnitude for each range. The statistics engine may create the third representation by establishing ranges of data values for the third representation in dependence upon ranges from both the first and second representations and determining a magnitude for each range of data values in the third representation in dependence upon magnitudes for ranges of data values from the first and second representations. At least one of the magnitudes for at least one of the ranges of data values in the second representation typically is more accurate than a magnitude for a corresponding range of data values in the first representation.

Also stored in RAM (168) is an operating system (154). Operating systems useful in computers according to embodiments of the present invention include UNIX™, Linux™, Microsoft NT™, AIX™, IBM's i5os, and many others as will occur to those of skill in the art. Operating system (154), DBMS (106) and representations (302, 310, 320) in the example of FIG. 2 are shown in RAM (168), but many components of such software and data typically are stored in non-volatile memory (166) also.

Computer (152) of FIG. 2 includes non-volatile computer memory (166) coupled through a system bus (160) to processor (156) and to other components of the computer. Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 2 includes a communications adapter (167) for implementing connections for data communications to other computers. Such connections may include serial connections such as RS-232 connections, connections through external buses such as USB connections, connections through data communications networks such as TCP/IP connections, and others as will occur to those of skill in the art. Communications adapters implement the hardware level of connections for data communications through which one computer sends data communications another computer, directly or through a network. Examples of communications adapters useful for mirroring database statistics according to embodiments of the present invention include modems for wired dial-up connections, Ethernet (IEEE 802.3) adapters for wired network connections, and adapters for wireless network connections.

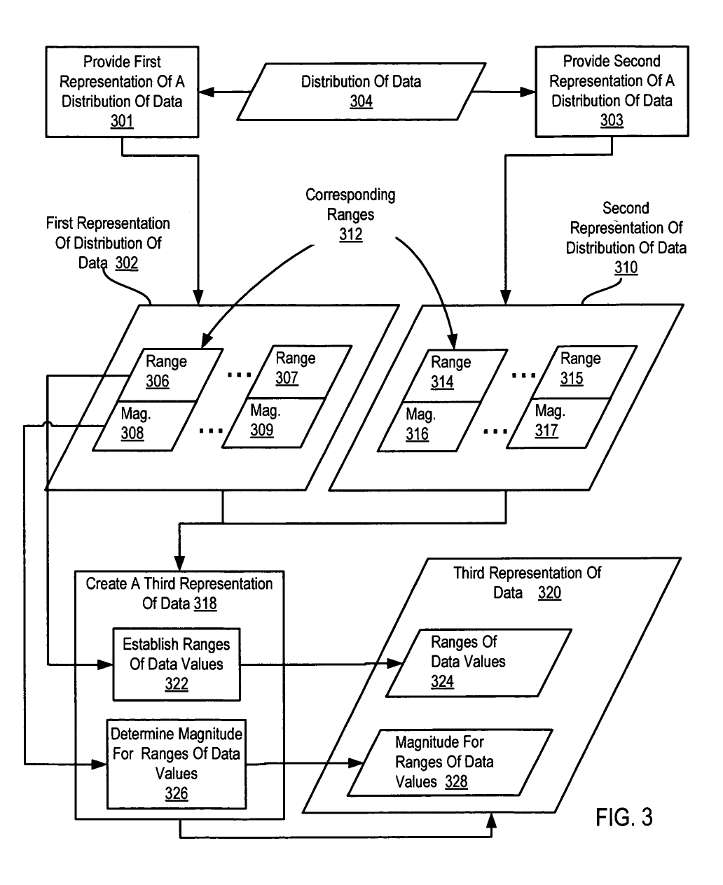

For further explanation, FIG. 3 sets forth a flow chart illustrating an exemplary method for representing a distribution of data (304) according to embodiments of the present invention that includes providing (301) a first representation (302) of the distribution of data (304). The first representation (302) of the distribution of data has defined ranges of data values (306, 307) and a magnitude (308, 309) for each range. Representations of a distribution of data typically are statistical indications of the likelihood or frequency of occurrence of data values in columns of a database.

Examples of representations of distributions of data include frequent value lists, histograms, splines, and others that will occur to those of skill in the art.

A range of data values may, for example, include one or more values of a column in a database. Thus, in the example discussed above with reference to FIG. 1, a range of values may include one or more storeID values, identifying one or more individual stores, in a transactions table. Each range of data values has a magnitude. A magnitude represents the number of times the value or values in the range of data values occurs in the data. A magnitude associated with a range of data values may be determined, for example, by counting the occurrences of a value in a column of a database. In another example, a magnitude associated with a range of data values may determined by approximation, e.g., using data sampling techniques.

The method illustrated in FIG. 3 also includes providing (303) a second representation (310) of the distribution of data (304) having defined ranges of data values (314, 315) and a magnitude (316, 317) for each range. As an example, the first representation may be a histogram, and the second representation may be a frequent values list.

In the method of FIG. 3, at least one of the magnitudes for at least one of the ranges of data values in the second representation (310) is more accurate than a magnitude for a corresponding range (312) of data values in the first representation (302). A corresponding range of data values is a range of data values in the first representation that includes a range of data values in the second representation. That is, corresponding ranges are ranges of data values of the first and second representations at least partially overlap. For example, if the first representation is a histogram and the second representation is a frequent values list, one or more ranges of data values in the frequent values list may fall within a range of data values of the histogram.

The magnitude for at least one of the ranges of data values in the second representation (310) typically is more accurate than a magnitude for a corresponding range (312) of data values in the first representation (302) as a result of the method of providing the magnitudes. For example, the second representation may be formed by an actual count of all occurrences of all data values in a distribution, whereas the first representation may be formed using statistical sampling techniques. In such an example, the actual count of all occurrences of all values provides a more accurate representation of the distribution than does the representation provided on the basis of statistical sampling.

The magnitude for at least one of the ranges of data values in the second representation (310) may be more accurate than a magnitude for a corresponding range (312) of data values in the first representation (302) as a result of the type of information stored by the representations. For example, the first representation may be a histogram which includes the number of occurrences of several values within a range of data values. The second representation may be a frequent values list. The second representation, the frequent values list in this example, may include an exact count of the number of occurrences of a single value in a range of data values and therefore be a more accurate representation of the distribution of data than a histogram describing occurrences in terms of ranges rather than specific values.

The method of FIG. 3 also includes creating (318) a third representation (320) of the distribution of data. Creating (318) the third representation (320) of the distribution of data includes establishing (322) ranges of data values (324) for the third representation (320) in dependence upon ranges from both the first (302) and second representations (310). Creating (318) the third representation (320) of the distribution of data further includes determining (326) a magnitude (328) for each range of data values in the third representation (320) in dependence upon magnitudes for ranges of data values from the first (302) and second representations (310).

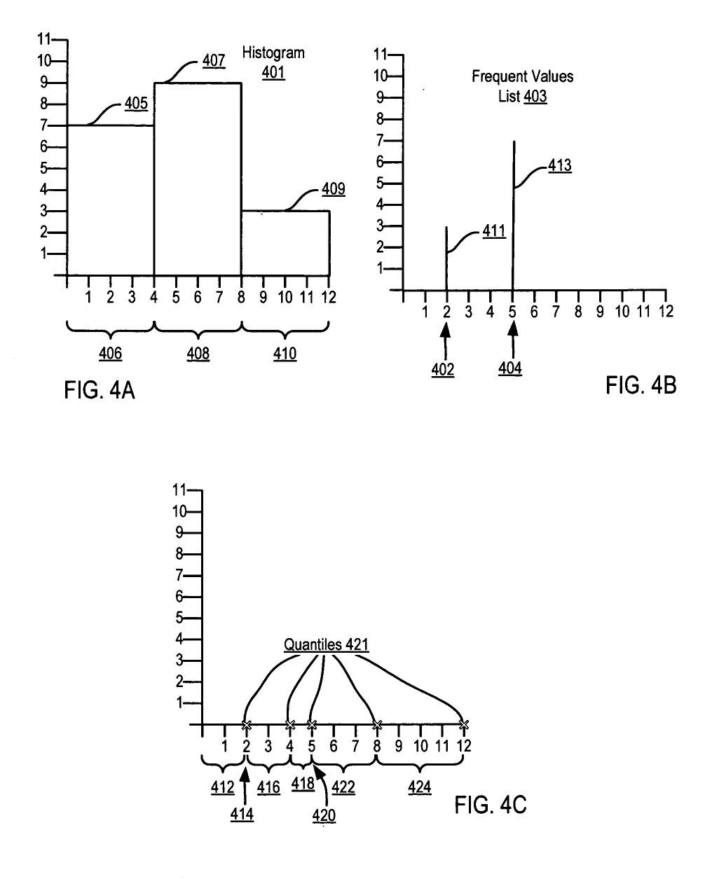

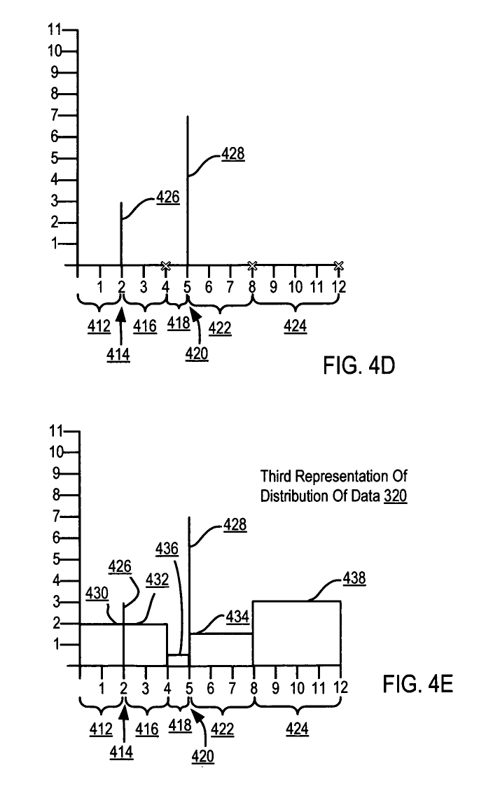

For further explanation, FIGS. 4A-4E set forth line drawings illustrating exemplary representations of a distribution of data and a process for creating a third representation from a first and second representation according to embodiments of the present invention. FIG. 4A illustrates a histogram (401). The histogram (401) of FIG. 4A has three ranges of data values (406, 408, 410). Each range of data values (406, 408, 410) has a magnitude (405, 407, 409). Each magnitude (405, 407, 409) represents a count of the number of occurrence of values within the respective range of data values (406, 408, 410). So, for example, magnitude (405) indicates that 7 values within the range of data values (406) from 0 to 4 occur within a column of a database table. Similarly, magnitude (407) indicates that 9 values within the range of data values (408) from 4 to 8 occur within the column of the database table. Likewise, magnitude (409) indicates that 3 values within the range of data values (410) from 8 to 12 occur within the column of the database table. The histogram (401) of FIG. 4A is shown as a graphical representation of the distribution of data for illustrative purposes only and is not intended to be limiting. A histogram useful for embodiments of the present invention may be either a graphical or non-graphical representation of a distribution of data. Many systems that represent distributions of data according to embodiments of the present invention will represent a histogram, for example, only in numeric data describing ranges and magnitudes for the ranges having no particular graphic content.

FIG. 4B illustrates a frequent values list (403). The frequent values list (403) of FIG. 4B has two magnitudes (411, 413) 3 and 7 representing two counts of actual occurrences of two values 2 and 5 in a column of a table in a database. Each counted value, 2 and 5, represents a range of values (402, 404) having only one value in the range. That is, 2 is the range of values (402) between 1 and 3 having only one value in the range, 2. Similarly, 5 is the range of values (404) between 4 and 6, a range having only one value in the range, 5. The frequent values list (403) of FIG. 4B is shown as a graphical representation of the distribution of data for illustrative purposes only, and is not intended to be limiting. A frequent values list useful for embodiments of the present invention may be either a graphical or non-graphical representation of a distribution of data. Many systems that represent distributions of data according to embodiments of the present invention will represent a frequent values list, for example, only in numeric data describing values and magnitudes for the values with no particular graphic content. FIGS. 4A and 4B together illustrate corresponding ranges of data values. A corresponding range of data values is a range of data values in the first representation that includes a range of data values in the second representation. As illustrated in FIGS. 4A and 4B, range of data values (402) of frequent values list (403), falls within range of data values (406) of histogram (401). Thus, range of data values (402) and range of data values (406) are corresponding ranges of data values. Corresponding ranges of data values include magnitude information about some of the same data values. However, the information provided by one of the representations of the distribution of data may be more accurate. For example, magnitude (411) in frequent values list (403) is more accurate with regard to the number of occurrences of the value 2 than magnitude (406) in the histogram (401) is for this same value.

In an embodiment of the present invention, a method of representing a distribution of data includes establishing ranges of data values for a third representation of the distribution of data. FIG. 4C illustrates established ranges of data values (412, 414, 416, 418, 420, 422, 424) for a third representation of the distribution of data. The ranges of data values illustrated in FIG. 4C are established in dependence upon the ranges of data values the first representation, i.e., histogram (401) and the ranges of data values from the second representation, i.e., frequent values list (403). That is, ranges of data values (414, 420) are established in dependence upon ranges of data values (402, 404) from frequent values list (403). Ranges of data values (412, 416, 418, 422, 424) are established in dependence upon ranges of data values (406, 408, 410) from histogram (401) as they are divided up by ranges of data values (402, 404) from frequent values list (403).

The ranges of data values (412, 414, 416, 418, 420, 422, 424) in FIG. 4C may be defined by quantiles (421). Quantiles (421) defining ranges of data values of the third representation of the distribution of data may then be established in dependence upon the quantiles defining the ranges of data values from both the first and second representation, e.g., histogram (401) and frequent values list (403), respectively. As used herein, “quantiles” refers to dividing points between ranges of data values. Using quantiles to define ranges of data does not mean, as the term ‘quantile’ is used here, that the ranges so defined are of equal size, and in fact, the ranges of data often will not be of equal size.

In an embodiment of the present invention, a method of representing a distribution of data includes determining a magnitude for each range of data values in the third representation in dependence upon magnitudes for ranges of data values from the first and second representations. FIG. 4D illustrates established magnitudes (426, 428) for several ranges of data values (414, 420) for a third representation of the distribution of data. The magnitudes (414, 420) illustrated in FIG. 4D are established in dependence upon magnitudes (402, 404) from the second representation, i.e., frequent values list (403). Thus, magnitude (414) in FIG. 4D indicates a count of 3 occurrences of the value 2 in the distribution of data as does magnitude (411) of frequent values list (403), shown in FIG. 4B. Also, magnitude (420) in FIG. 4D indicates a count of 7 occurrences of the value 5 in the distribution of data as does magnitude (413) of frequent values list (403), shown in FIG. 4B.

FIG. 4E illustrates a third representation (320) of a distribution of data. The third representation (320) is completed by establishing magnitudes (430, 432, 434, 436, 438) for ranges of data values (412, 416, 418, 422, 424) that did not have established magnitudes in FIG. 4D. The magnitude (438) illustrated in FIG. 4E is established in dependence upon magnitude (409) from the first representation, i.e., histogram (401). Magnitude (438) indicates 3 occurrences of values within the range of 8 to 12, as does magnitude (410) of histogram (401), shown in FIG. 4A.

Magnitudes (430, 432, 434, 436) are established in dependence upon magnitudes (402, 404) from the second representation, i.e., frequent values list (403), magnitudes (405, 407, 409) from the first representation, i.e., histogram (401), and the relative sizes of range of data values (406, 408, 410) of the first representation, i.e., histogram (401) and the ranges of data values of the third representation (320). For example, magnitudes (430, 432) are established by subtracting magnitude (426) from magnitude (405) and apportioning the difference in the magnitudes between ranges of data values (412, 416). That is, the 3 counts of the value 2 indicated by magnitude (426) are subtracted from the 7 counts of values with the range of 0 to 4 indicated by magnitude (406), leaving 4 counts to be distributed between the range of data values (412) from 0 to 2 and the range of data values (416) from 2 to 4. Range of data values (412) and range of data values (416) of the third representation (320) each include half of the range of data values (406) of histogram (401). Therefore, one half of the 4 counts is assigned to each of the ranges of data values (412, 416) of the third representation (320). Thus, magnitude (430) for range of data values (412) shows 2 occurrences of data values within the range of 0 to 2, and magnitude (432) for range of data values (416) shows 2 occurrences of data values within the range of 2 to 4.

In another example, magnitudes (434, 436) are established by subtracting magnitude (428) from magnitude (407) and apportioning the difference in the magnitudes between ranges of data values (418, 422). That is, the 7 counts of the value 5 indicated by magnitude (428) are subtracted from the 9 counts of values with the range of 4 to 8 indicated by magnitude (407), leaving 2 counts to be distributed between the range of data values (418) from 4 to 5 and the range of data values (422) from 5 to 8. Range of data values (418) includes one fourth of the range of data values (408) of histogram (401) so, one fourth of the 2 counts is assigned to range of data values (418) of the third representation (320) giving a magnitude (434) of one half count. Range of data values (422) includes three fourths of the range of data values (408) of histogram (401) so, three fourths of the 2 counts is assigned to range of data values (422) of the third representation (320) giving a magnitude (436) of one and one half counts.

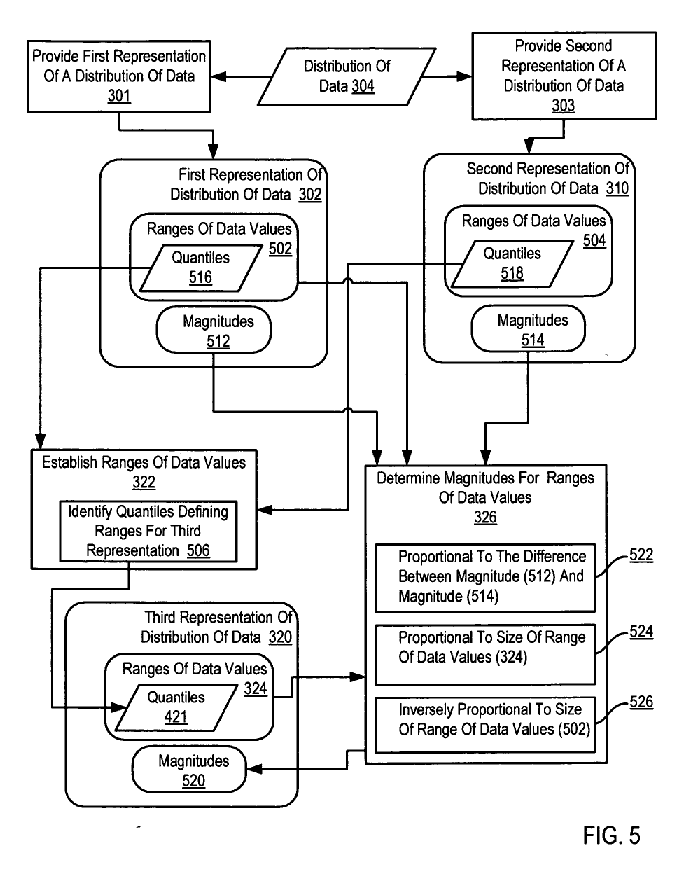

For further explanation, FIG. 5 sets forth a flow chart illustrating an exemplary method of representing a distribution of data (304) according to embodiments of the present invention that includes providing (301) a first representation (302) of the distribution of data (304) and providing (303) a second representation (310) of the distribution of data (304). Both the first representation (302) and the second representation (310) have ranges of data values (502, 504) defined by quantiles (516, 518). Both the first representation (302) and the second representation (310) also have magnitudes (512, 514) for each range of data values (502, 504).

Ranges of data values (324) for the third representation (320) of the distribution of data are established (322) by identifying (506) quantiles (421) defining ranges of data values (324) of the third representation (320) in dependence upon the quantiles (516) defining the ranges of data values (502) for the first representation (302) and quantiles (518) defining the ranges of data values (504) for the second representation (310). For example, quantiles (421) of the third representation (320) may include all of the quantiles (516, 518) of the first (302) and second representations (310).

The method of FIG. 5, also includes determining (326) the magnitudes (520) for ranges of data values (324) in the third representation (320) in dependence upon ranges of data values (324) in the third representation (320). More particularly, the method of FIG. 5 includes determining (326) the magnitude (520) for a range of data values (324) in the third representation (320) by determining a magnitude (520) for a range of data values (324) in the third representation (320) that is proportional (522) to the difference between a magnitude (512) for a range of data values (502) from the first representation (302) and a magnitude(514) for a range of data values (504) from the second representation (310), proportional (524) to a size of the range of data values (324) for the third representation (320), and inversely proportional (526) to a size of the range of data values (502) for the first representation (302).

Again with reference to FIG. 4E, for example, magnitude (436) of range of data values (418) of the third representation (320) may be determined by the equation:

$$Magnitude 3 = \frac{( Magnitude 1 - Magnitude 2 ) * SizeOfRange 3}{SizeOfRange 1}$$

where:
Magnitude3 is the magnitude of the third representation (320) that is being determined,
Magnitude1 is the magnitude of the range of data values of the first representation that includes a range of data values from the second representation,
Magnitude2 is the magnitude of the range of data values from the second representation that is included within the range of data values of the first representation,
SizeOfRange3 is the size of the range of data values of the third representation, and
SizeOfRange1 is the size of the range of data values of the first representation.

For further clarification, following is an example of determining magnitude (436) of range of data values (418). Range of data values (418) includes the range of data values from 4 to 5. The size of range of data values (418) is equal to 1 (i.e., 5−4 =1), so SizeOfRange3=1. Referring to FIG. 4A, the range of data values for the first representation, histogram (401) in this example, that includes the range of data values from 4 to 5 is range of data values (408). Range of data values (408) has a magnitude (407) of 9. Therefore, Magnitude1=9. The size of range of data values (408) is 4 (i.e., 8−4=4), so SizeOfRange1 32 4. Referring to FIG. 4B, the range of data values for the second representation, frequent values list (401) in this example, that is within the range of data values from 4 to 8 is range of data values (404). Range of data values (404) has a magnitude (413) of 7. Therefore, Magnitude2=7. The Magnitude3 determination equation then becomes:
Magnitude3 =(9−7)*(¼).
Magnitude3=½.

So, range of data values (418) in FIG. 4E has a magnitude (436) of ½.

Exemplary embodiments of the present invention are described largely in the context of a fully functional computer system for representing a distribution of data. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for representing a distribution of data, the method comprising:
providing a first representation of the distribution of data having defined ranges of data values and a magnitude for each range;
providing a second representation of the distribution of data having defined ranges of data values and a magnitude for each range, wherein at least one of the magnitudes for at least one of the ranges of data values in the second representation is more accurate than a magnitude for a corresponding range of data values in the first representation; and
creating a third representation of the distribution of data, including:
establishing ranges of data values for the third representation in dependence upon ranges from both the first and second representations; and
determining a magnitude for each range of data values in the third representation in dependence upon magnitudes for ranges of data values from the first and second representations.

2. The method of claim 1 wherein a corresponding range of data values comprises a range of data values in the first representation that includes a range of data values in the second representation.

3. The method of claim 1 wherein the first representation of the distribution of data comprises a histogram and the second representation of the distribution of data comprises a frequent values list.

4. The method of claim 1 wherein the first representation of the distribution of data comprises a histogram and the second representation of the distribution of data comprises a spline.

5. The method of claim 1 wherein:
the ranges of data values are defined by quantiles; and
establishing ranges of data values for the third representation further comprises identifying quantiles defining ranges of data values of the third representation in dependence upon the quantiles defining the ranges for the first representation and the second representation.

6. The method of claim 1 wherein determining the magnitude for a range of data values in the third representation comprises determining the magnitude for the range in the third representation in further dependence upon the range of data values in the third representation.

7. The method of claim 1 wherein determining the magnitude for a range of data values in the third representation comprises determining a magnitude for a range of data values in the third representation that is:
proportional to the difference between a magnitude for a range of data values from the first representation and a magnitude for a range of data values from the second representation,
proportional to a size of the range of data values for the third representation, and inversely proportional to a size of the range of data values for the first representation.

8. A system for representing a distribution of data, the system comprising a computer processor, a computer memory operatively coupled to the computer processor, the computer memory having disposed within it computer program instructions capable of:
providing a first representation of the distribution of data having defined ranges of data values and a magnitude for each range;
providing a second representation of the distribution of data having defined ranges of data values and a magnitude for each range, wherein at least one of the magnitudes for at least one of the ranges of data values in the second representation is more accurate than a magnitude for a corresponding range of data values in the first representation; and
creating a third representation of the distribution of data, including:
establishing ranges of data values for the third representation in dependence upon ranges from both the first and second representations; and
determining a magnitude for each range of data values in the third representation in dependence upon magnitudes for ranges of data values from the first and second representations.

9. The system of claim 8 wherein a corresponding range of data values comprises a range of data values in the first representation that includes a range of data values in the second representation.

10. The system of claim 8 wherein:
the ranges of data values are defined by quantiles; and
establishing ranges of data values for the third representation further comprises identifying quantiles defining ranges of data values of the third representation in dependence upon the quantiles defining the ranges for the first representation and the second representation.

11. The system of claim 8 wherein determining the magnitude for a range of data values in the third representation comprises determining the magnitude for the range in the third representation in further dependence upon the range of data values in the third representation.

12. The system of claim 8 wherein determining the magnitude for a range of data values in the third representation comprises determining a magnitude for a range of data values in the third representation that is:
proportional to the difference between a magnitude for a range of data values from the first representation and a magnitude for a range of data values from the second representation,
proportional to a size of the range of data values for the third representation, and
inversely proportional to a size of the range of data values for the first representation.

13. A computer program product for representing a distribution of data, the computer program product disposed upon a signal bearing medium, the computer program product comprising computer program instructions capable of:
providing a first representation of the distribution of data having defined ranges of data values and a magnitude for each range;
providing a second representation of the distribution of data having defined ranges of data values and a magnitude for each range, wherein at least one of the magnitudes for at least one of the ranges of data values in the second representation is more accurate than a magnitude for a corresponding range of data values in the first representation; and
creating a third representation of the distribution of data, including:
establishing ranges of data values for the third representation in dependence upon ranges from both the first and second representations; and
determining a magnitude for each range of data values in the third representation in dependence upon magnitudes for ranges of data values from the first and second representations.

14. The computer program product of claim 13 wherein the signal bearing medium comprises a recordable medium.

15. The computer program product of claim 13 wherein the signal bearing medium comprises a transmission medium.

16. The computer program product of claim 13 wherein a corresponding range of data values comprises a range of data values in the first representation that includes a range of data values in the second representation.

17. The computer program product of claim 13 wherein the first representation of the distribution of data comprises a histogram and the second representation of the distribution of data comprises a frequent values list.

18. The computer program product of claim 13 wherein:
the ranges of data values are defined by quantiles; and
establishing ranges of data values for the third representation further comprises identifying quantiles defining ranges of data values of the third representation in dependence upon the quantiles defining the ranges for the first representation and the second representation.

19. The computer program product of claim 13 wherein determining the magnitude for a range of data values in the third representation comprises determining the magnitude for the range in the third representation in further dependence upon the range of data values in the third representation.

20. The computer program product of claim 13 wherein determining the magnitude for a range of data values in the third representation comprises determining a magnitude for a range of data values in the third representation that is:
proportional to the difference between a magnitude for a range of data values from the first representation and a magnitude for a range of data values from the second representation,
proportional to a size of the range of data values for the third representation, and
inversely proportional to a size of the range of data values for the first representation.
